(19) United States
(12) Patent Application Publication
(10) Pub. No.: US 2014/0007838 A1
(43) Pub. Date: Jan. 9, 2014

(54) ALTERNATIVE FUEL COMBUSTION ENGINE ENHANCER

(71) Applicant: A PADLE, LLC, Moses Lake, WA (US)

(72) Inventor: Michael W. Archer, Moses Lake, WA (US)

(73) Assignee: A PADLE, LLC

(21) Appl. No.: 13/912,070

(22) Filed: Jun. 6, 2013

Related U.S. Application Data
(60) Provisional application No. 61/656,679, filed on Jun. 7, 2012.

(51) Int. Cl. F02M 25/025

(52) U.S. Cl. CPC F02M 25/025
USPC 123/25 R

(57) ABSTRACT

An alternative fuel combustion engine enhancer for the vast improvement of combustion engines through a greener environment with lowered emissions, decreased fuel consumption, increased engine life and increased power. The alternative fuel combustion engine enhancer generally includes Copper Pipes, Stainless Steel Rods, Stainless Steel Wire, Silver Solder, Machined Acrylic End Caps, Copper Wire, a Water Supply, a Wiring Harness, and a Control Panel.

### CROSS-REFERENCE TO RELATED APPLICATION

This non-provisional patent application claims priority from and the benefit of the filing date of co-pending Provisional Patent Application Ser. No. 61/656,679 filed Jun. 7, 2012 titled “ALTERNATIVE FUEL COMBUSTION ENGINE ENHANCER” by Michael W. Archer in accordance with 35 U.S.C. §§119(e) and 120.

### TECHNICAL FIELD

This invention relates to hydrolysis units for combustion engines. More specifically, the invention relates to open loop hydrolysis units for internal combustion engines.

### BACKGROUND OF THE INVENTION

The use of hydrogen and/or oxygen gas as a fuel component for internal combustion engines is well known. In such applications, the production of hydrogen and/or oxygen gas for combustion purposes is often produced through electrolysis of water. As is well known to those of ordinary skill in the art, pure water can be broken down into hydrogen and oxygen gas (H₂, O₁) by placing electrodes in water and providing a voltage potential across the electrodes. Hydrogen gas will accumulate around the cathode while oxygen gas will accumulate around the anode, according to the well known formulas:

Cathode: 2H₂O(1)+2e⁻→H₂(g)+2OH⁻(aq); and

Anode: 2H₂O(1)→O₂(g)+4H⁺(aq)+4e⁻.

The overall reaction for both electrodes when the formulas are combined and reduced leads to the well known formula:

2H₂O(1)→2H₂(g)+O₂(g)

In the context of internal combustion engines, electrolyzed hydrogen gas or oxygen gas or both can be and have been applied to an internal combustion engine. Systems of this type generally constitute closed cycle/closed loop systems, or open cycle/open loop systems.

Published U.S. Patent Application Nos. US2002/0117125 A1 and 0074680 A1 by McMaster, et al. describe a typical closed loop or closed cycle hydrogen or oxygen gas fuel system for use with an internal combustion engine. In the applications filed by McMaster, et al., hydrogen gas and oxygen gas are separated through electrolysis and then stored in accumulators through one-way check valves. The oxygen and hydrogen gas are then introduced to an internal combustion engine and the exhaust is passed through a condenser which recycles the condensed water back into the electrolytic chamber. Thus, water, in general is not lost to the atmosphere and the system is essentially closed loop.

Published U.S. Patent Application US2011/0290201 A1 by Owens discloses a hydrogen supplemental system for on-demand hydrogen generation for internal combustion engines which operates in an open loop mode. In the system described by Owens, oxygen is vented to the atmosphere while hydrogen gas is directed to the engine air intake for combustion purposes.

Mosher, et al. describe in U.S. Pat. No. 6,257,175 an oxygen and hydrogen generator apparatus for internal combustion engines in which oxygen from an electrolytic cell is fed into the intake manifold of the internal combustion engine, while the hydrogen gas is fed directly into the pre-ignition combustion chambers. Water in the system described by Mosher, et al. used by the generator apparatus is replenished from a reservoir. The water used in the generator apparatus is accordingly kept at a desired level.

Thus, a variety of systems are contemplated in the prior art which generate either oxygen or hydrogen gas or both for combustion in an internal combustion engine in either open or closed loop modes. Nevertheless, such prior art devices suffer from various practical problems including excess heating and high corrosion, particularly where a catalyst or electrolyte is introduced into the water prior to electrolysis. Some prior art devices extract hydrogen and oxygen gas from water by force which produces excess heat and steam, other units have very high power consumptions as they are adapted to produce all or substantially all of the combustion gasses needed to operate the internal combustion engine. Other prior art devices have a short life because of corrosion or have complex electrical systems to make their units operate properly.

Therefore a need exists to provide an alternative fuel combustion engine enhancer that significantly lowers emissions on combustion engines, is safe for the environment, provides an increase in power in a combustion engine and that provides a balanced production of hydrogen oxygen gas.

### BRIEF SUMMARY OF THE INVENTION

It is therefore an object of the present invention to provide for an alternative fuel combustion engine enhancer for the vast improvement of combustion engines through a greener environment with lowered emissions, decreased fuel consumption, increased engine life and increased power.

Another object is to provide an Alternative Fuel Combustion Engine Enhancer that significantly lowers emissions on internal combustion engines.

Another object is to provide an Alternative Fuel Combustion Engine Enhancer that is safe for the environment.

Another object is to provide an Alternative Fuel Combustion Engine Enhancer that provides a significant increase in power (varies with different types of engines).

Another object is to provide an Alternative Fuel Combustion Engine Enhancer that A PADLE has a balanced production of hydrogen and oxygen.

Another object is to provide an Alternative Fuel Combustion Engine Enhancer that produces very pure hydrogen that is extremely powerful and clean. When properly installed, A PADLE should yield between 10% and 50% improvement in fuel economy depending on the engine size and the “A PADLE” size.

The present invention relates generally to, Archer's A PADLE (Archer's petroleum alternative duel life energy) and more specifically it relates to an alternative fuel combustion engine enhancer for the vast improvement of combustion engines through a greener environment with lowered emissions, decreased fuel consumption, increased engine life and increased power.

The invention achieves the above objects, and other objects and advantages which will become apparent from the description which follows, by providing an open loop, catalyst free pure water hydrolysis unit for use with a combustion engine. The hydrolysis unit includes a plurality of concentric, spaced apart tubular cathodes having continuous side walls and upper and lower ends forming closed surfaces. The cathodes are electrically interconnected to one another and to a direct current power source for generating hydrogen gas. The unit also includes a plurality of anodes in the form of elongated, conductive rods having upper and lower ends including interconnections between the anodes as well as to the direct current source for generating oxygen gas. Upper and lower substantially nonconductive end caps having concentric circular grooves for receipt of the cylindrical cathodes as well as a plurality of receptacles for receiving the upper and lower ends of the anodes are provided. Preferably, the end caps define a plurality of apertures for permitting convention flow of water from the lower to the upper end caps and return flow across the anodes and cathodes for cooling purposes and to dislodge gas generated in and around the electrodes. The unit is preferably connected to the intake of an internal combustion engine to combust and recombine the hydrogen and oxygen gas for generating power, reducing emissions and to render a clean air and more stochastically correct combustion cycle.

In a preferred embodiment of the invention, the anode and cathode of the unit are connected to a conventional automotive battery through an ignition switch and an under—on/off switch through a conventional relay. The unit is preferably contained in a container having a water manifold and a water reservoir to replenish water which is depleted from the unit through the hydrolysis process. The electrical system may also be connected in series with an oil pressure switch connected to the internal combustion engine such that upon failure of the engine either due to a decrease in oil pressure or through normal operation when the engine is switched off the unit will not generate any combustible gasses.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side elevational view of an electrolysis unit of the present invention.

FIG. 2 is a sectional perspective view of the electrolysis unit of the present invention illustrating the anodes, cathodes and end caps of the electrolysis unit. This is the view of three copper pipes and the end pieces.

FIG. 3 is an upper perspective view of an end cap of the present invention.

FIG. 4 is a schematic representation of fluid flow in the hydrolysis unit of the present invention.

FIG. 5 is a schematic representation of the present invention installed in an internal combustion engine environment.

### DETAILED DESCRIPTION OF THE PREFERRED EMBODIMENTS

An alternative fuel combustion engine enhancer hydrolysis unit in accordance with the principles of the invention is generally indicated at reference numeral 10 in the various Figures of the attached drawings wherein numbered elements in the figures correspond to like numbered elements herein.

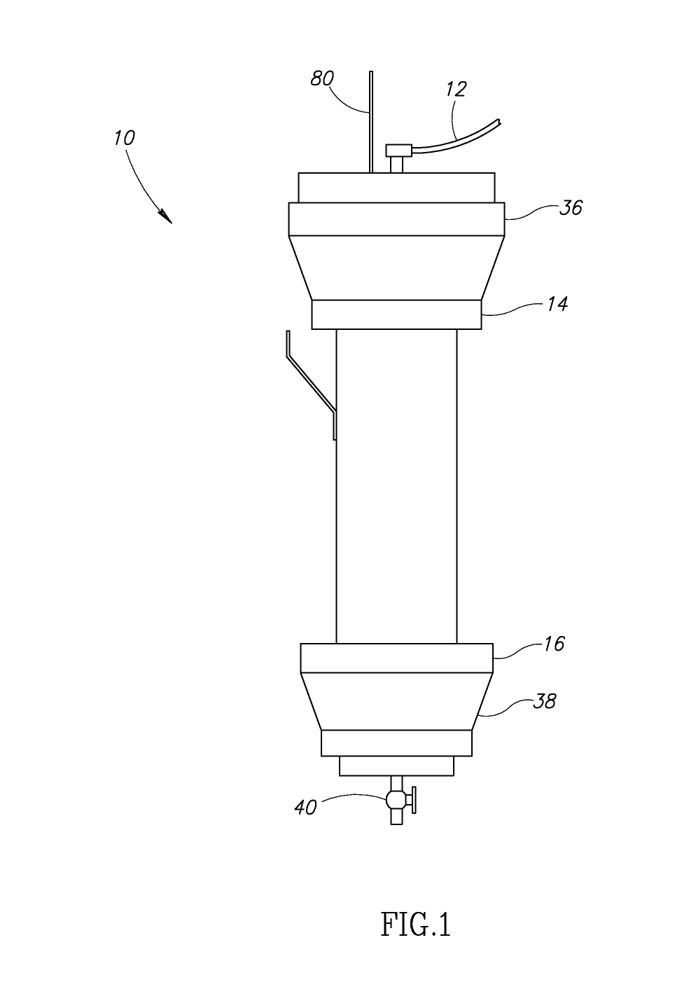

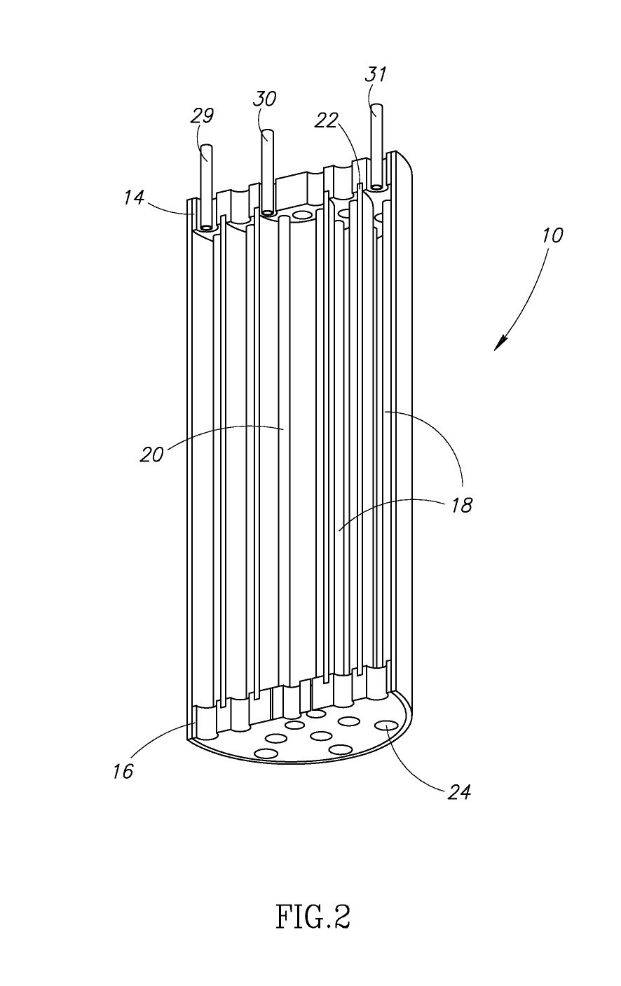

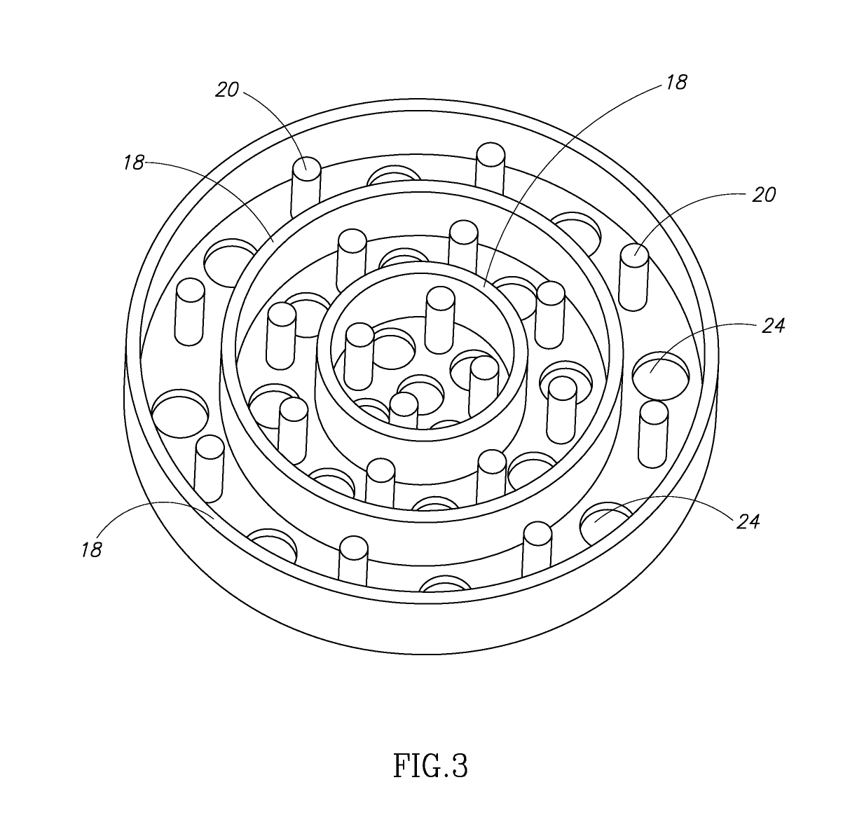

With reference to FIGS. 1 and 2, the unit 10 generally produces free hydrogen and oxygen gas through a hydrogen oxygen outlet 12 which may be used as combustion gasses in an internal combustion engine or the like as will be described herein below in greater detail. The unit 10 has upper and lower end caps 14, 16 preferably manufactured from a nonconductive polymer such as machined acrylic. FIG. 2 illustrates the unit 10 in section so as to illustrate the end caps 14, 16 and the concentrically arranged, tubular cathodes 18 and elongated rod-like anodes 20 which are received in the end caps 14, 16. The lower end cap 16 is best seen in FIG. 3 in which concentric grooves are machined in the end caps 14, 16 for receipt of upper and lower ends, respectively of the cathode side walls. The end caps further define receptacles into which upper and lower ends of the anodes are also received such that the end caps 14, 16, anodes 20 and cathodes 18 together form a structurally cohesive unit. The end caps 14, 16 further define fluid apertures 24 through which water undergoing electrolysis (not shown) may flow vertically so as to cool the unit through convention currents set up in the water inside the unit as well as off-gassing of oxygen and hydrogen which contribute to the fluid dynamics of the unit. The three sets of concentric, tubular cathodes 18 are provided with insulated conductors 29, 30 and 31 for connecting the cathodes in a conventional manner to a source of direct current, such as an automotive battery as will be described herein below. The anode rods 20 are also similarly electrically interconnected by wires (not shown) to the opposite polarity of the direct current power supply.

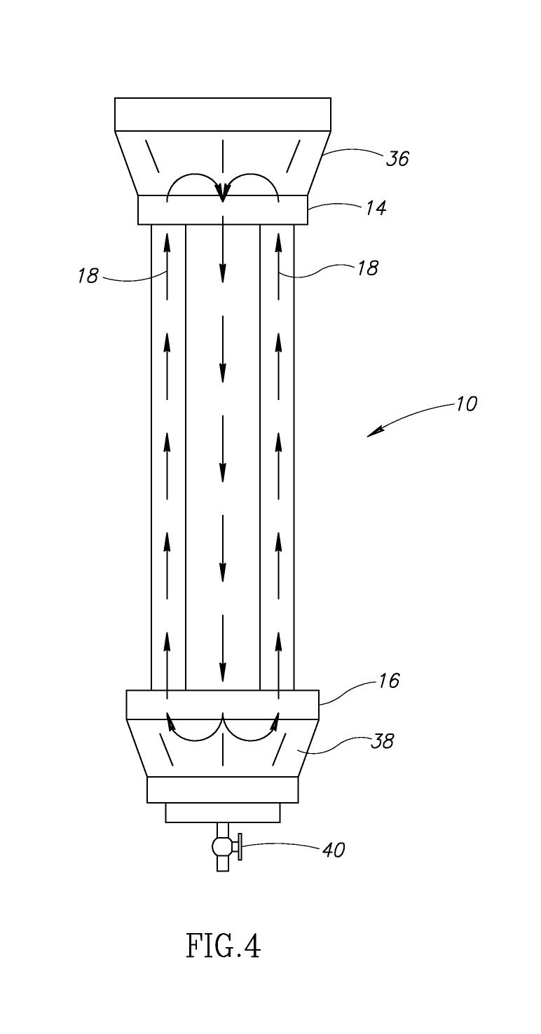

FIG. 4 illustrates that the lower end cap 16 includes the cathodes 18, anodes 20, apertures 24 all received or defined by the lower end cap 16. Those of ordinary skill in the art will appreciate that the upper end cap is identical to the lower end cap.

When assembled as shown in FIG. 2, the unit 10 permits fluid as best see in FIG. 4 to circulate in a vertical pattern about the electrodes. When the unit 10 is fully assembled, upper and lower manifolds 36, 38 permit water to flow vertically along the sides of the outermost cathodes 18 and down through the inside of the innermost cathode through the fluid apertures 24 due to convection caused by temperature differentials and the vertical orientation of the unit 10. A drain 40 may be provided at a bottom end of the lower manifold 38 to empty the unit such as for removal from a vehicle and servicing.

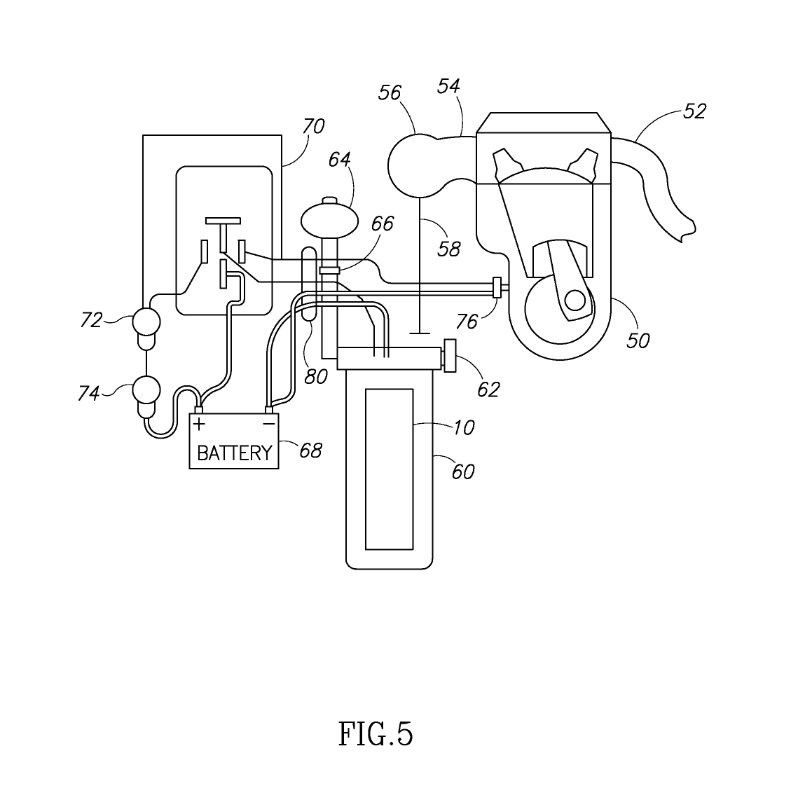

FIG. 5 illustrates the hydrolysis unit 10 installed in an automotive environment including an engine of the internal combustion type having an exhaust manifold 52 and an intake manifold 54 connected to a throttle body 56. The throttle bottle 56 is connected by a gas conduit 58 to the outlet 12 of the unit 10 so that the generated hydrogen and oxygen gasses may be introduced to the engine through the intake manifold 54 for combustion along with any fossil fuel/air mixture normally used by the engine. The unit 10 is preferably received in a fluid impermeable container 60 connected to a water manifold 62 at an upper end thereof to be in fluid communication with a water tank 64 and valve 66 which maintains the water in the manifold 62 at a desired level so that the hydrolysis unit 10 does not run dry as gas is produced. As previously stated, the cathodes and anodes of the unit 10 may be connected to an automotive battery 68 to power the unit when the engine 50 is running. To this end, the cathode is interconnected through a conventional automotive relay 70 to an under—on/off switch 72 and the automotive ignition switch 74 as well as an oil pressure sensing switch 76 all in series such that the electrolysis unit 10 only generates combustible gasses when the engine is running.

### A. Overview

Turning now descriptively to the specific elements described above, in which similar reference numerals denote similar elements throughout the several views, the Figures illustrate Copper Pipes (cathodes 18), Stainless Steel Rods (anodes 20), Machined Acrylic End Caps (14, 16), Copper Wire (29, 30, 31), a Water Supply (64) and a Wiring Harness (80).

### B. Copper Pipes

There are three copper pipes 18. The exterior copper pipe is 7¾″ long by 3″ diameter and 0.065″ wall thickness. The two interior copper pipes are 7¼″ long and 2″ and 1″ diameter respectively. They also are 0.065″ wall thickness. The function is to create hydrogen.

One, 1″ diameter copper pipe by 0.065″ thick.

One, 2″ diameter copper pipe by 0.065″ thick.

One, 3″ diameter copper pipe by 0.065″ thick.

All three copper pipes can be lengthened or shortened to adjust hydrogen output, and the number of copper pipes can be increased or decreased according to need. The copper pipes can be round, flat, or shaped according to need.

### C. Stainless Steel Rods

There are twenty stainless steel rods 20. Nineteen rods are the same length and one rod is 4″ longer. The stainless is 316L. The diameter is 0.125″. All twenty rods create oxygen. The 4″ longer rod also provides a platform for a positive connection to the other nineteen rods and connects to the A PADLE control circuit (A PADLE wiring harness 80).

The rods can be lengthened or shortened to coincide with various size cores, and the number of rods may vary according to need.

### D. Machined Acrylic End Caps

The two acrylic end caps 14, 16 are 2 ⅞″ in diameter by ½″ thick and machined to hold the two internal copper pipes 18 and stainless steel rods 26 in position.

The acrylic end caps can be increased or decreased in diameter to match the core if the core size is changed.

### E. Copper Wire

There are three copper wires 29, 30, 31. The shielded copper wire is 10″ long and 12-gauge, soldered to each of the three copper pipes with lead-free silver solder. This copper wire makes a negative connection to the power source.

The three shielded copper wires are 2″ long and 12-gauge, soldered to the three copper pipes with lead-free silver solder. This copper wire makes a negative connection to the power source.

The copper wire may be lengthened or shortened depending on the needs of the core.

### F. Water Supply

The water supply reservoir 64 can be from different containers of different sizes. G. Wiring Harness

The wiring harness 80 (see FIG. 5) provides the connection from the A PADLE to the various points on the vehicle.

The wiring harness connects the A PADLE unit 10 to the engine 50.

The wiring harness can be lengthened or shortened depending on the engine application.

### H. Connections of Main Elements and Sub-Elements of Invention

The copper pipes 18 are connected by the copper wires 29, 30, 31 and then to the battery 68 negative.

The stainless steel rods 20 are connected by the stainless steel wire (not shown) which connects to the A PADLE control circuit relay 70.

### I. Alternative Embodiments of Invention

The A PADLE can be lengthened or shortened to alter hydrogen output.

### J. Operation of Preferred Embodiment

When A PADLE unit 10 is active, the oxygen and hydrogen bubbles produced by electrolysis in the water rise to the surface through the centers of the copper pipes 18. A small amount of heat is produced. When the oxygen and. hydrogen bubbles reach the top surface, they are drawn into the engine through the air intake 54 to the engine 50.

The inside pipe 18 flow of warm water forces the cooler water on the outside of the pipe to descend causing the flow of water. See FIG. 4. An absence of water only stops the production of hydrogen and has no other effect on the gasoline, diesel, or propane engine. The standard water supply holds variable amounts of water. The A PADLE unit 10 is easily serviced by replacing the water in the A PADLE reservoir 64. Two or more units 10 would be used for large trucks and large equipment. The life expectancy before main element service or replacement is expected to be 100k-plus consecutive miles.

Hydrogen and oxygen gas are not stored. The success of the A PADLE unit 10 is the result of the unique flow of H₂O from which the gas is gradually extracted from the H₂O for combustion in the engine. A PADLE unit 10 will not work properly with the use of salt water or sea water or with any additive catalyst in the water.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

Thus, those of ordinary skill in the art will conceive of other alternate embodiments of the invention upon reviewing this disclosure. Thus, the invention is not to be limited to the above description, but is to be determined in scope by the claims which follow.

I claim:

1. An open loop, catalyst free, pure water hydrolysis unit for use with a combustion engine, comprising:
an elongated, hollow cathode having a continuous sidewall and upper and lower ends forming a closed surface, including means for connecting the cathode to a direct current power source for generating hydrogen gas;
a plurality of anodes in the form of elongated, conductive rods having upper and lower ends including means for connecting the anodes to one another and to the direct current source for generating oxygen gas; and
upper and lower substantially non-conductive end caps each having a groove for receipt of the cathode upper and lower ends, a plurality of receptacles for receiving the anode upper and lower ends and defining a plurality of apertures for permitting passive convection flow of water from the lower to upper end caps.

2. The hydrolysis unit of claim 1 wherein, the cathode is cylindrical and the grooves in the end caps are circular.

3. The hydrolysis unit of claim 2 including a plurality of electrically interconnected cylindrical cathodes and a corresponding plurality of end cap grooves for receipt thereof.

4. The hydrolysis unit of claim 1 wherein, the combustion engine is an internal combustion engine and the hydrolysis unit includes electronic control means for electrically interconnecting the unit with a vehicle battery, a vehicle ignition switch and an oil pressure switch such that the gasses from the unit are only generated when the engine is in operation.

5. The hydrolysis unit of claim 1 wherein, the cathode is substantially manufactured from copper.

6. The hydrolysis unit of claim 1 wherein, the anodes are substantially manufactured from stainless steel.

7. The hydrolysis unit of claim 1 wherein, the end caps are manufactured from an acrylic material.

8. The hydrolysis unit of claim 1, including an elongated, external, substantially fluid impermeable casing containing the unit and having means for venting the generated gasses to the combustion engine arid means for permitting controlled ingress of water to the unit to replace electrolyzed water removed from the unit.

9. An open loop, catalyst free, pure water hydrolysis unit for use with a combustion engine, comprising:
a plurality of concentric, spaced apart tubular cathodes having a continuous sidewalls and upper and lower ends forming closed surfaces, including means for connecting the cathodes to one another and to a direct current power source for generating hydrogen gas;
a plurality of anodes in the form of elongated, conductive rods having upper and lower ends including means for connecting the anodes to one another and to the direct current source for generating oxygen gas; and
upper and lower substantially non-conductive end caps each having concentric circular grooves for receipt of the cathode upper and lower ends, a plurality of receptacles for receiving the anode upper and lower ends and defining a plurality of apertures for permitting passive convection flow of water from the lower to upper end caps and return flow there from.

10. The hydrolysis unit of claim 9 wherein, the combustion engine is an internal combustion engine and the hydrolysis unit includes electronic control means for electrically interconnecting the unit with a vehicle battery, a vehicle ignition switch and an oil pressure switch such that the gasses from the unit are only generated when the engine is in operation.

11. The hydrolysis unit of claim 9 wherein, the cathode is substantially manufactured from copper.

12. The hydrolysis unit of claim 9 wherein, the anodes are substantially manufactured from stainless steel.

13. The hydrolysis unit of claim 9 wherein, the end caps are manufactured from an acrylic material.

14. The hydrolysis unit of claim 9 including an elongated, external, substantially fluid impermeable casing containing the unit and having means for venting the generated gasses to the combustion engine and means for permitting controlled ingress of water into the unit to replace electrolyzed water removed from the unit.

15. An open loop, catalyst free, pure water hydrolysis unit for use with a combustion engine, comprising
a plurality of concentric, spaced apart tubular cathodes having a continuous sidewalls and upper and lower ends forming closed surfaces, including means for connecting the cathodes to one another and to a direct current power source for generating hydrogen gas;
a plurality of anodes in the form of elongated, conductive rods having upper and lower ends including means for connecting the anodes to one another and to the direct current source for generating oxygen gas; and
upper and lower substantially non-conductive end caps each having concentric circular grooves for receipt of the cathode upper and lower ends and a plurality of receptacles for receiving the anode upper and lower ends.

16. The hydrolysis unit of claim 15, wherein the end caps define a plurality of apertures for permitting passive convection flow of water from the lower to upper end caps and return flow there from.
